(19) United States
(12) Patent Application Publication
(10) Pub. No.: US 2003/0018759 A1
(43) Pub. Date: Jan. 23, 2003

(54) Method and system for performing computer system cloning

(75) Inventor: Warren John Baumann, Monroe, NY (US)

Correspondence Address: Philmore H. Colburn II, Cantor Colburn LLP, 55 Griffin Road South, Bloomfield, CT, 06002, US

(73) Assignee: International Business Machines Corporation, Armonk, NY

(21) Appl. No.: 09/906,966

(22) Filed: Jul. 17, 2001

(51) Int. Cl. G06F 15/177

(52) U.S. Cl. 709/221; 709/223

(57) ABSTRACT

An exemplary embodiment of the present invention is a method and system for performing computer system cloning. A program on a client system requests a system image and a system customization from a server system. Space requirements are received from the server system and then the client system uses these space requirements to set up temporary storage space. An image file corresponding to the system image that was requested is then received from the server system and stored in the temporary storage space. The client system then recreates the system image from the image files. The image files are then deleted from the temporary storage space on the client system. A customization file corresponding to the requested system customization is then received from the server system and stored in the temporary storage space on the client system. The customization file is applied to the system image on the client system and then the temporary storage space is deleted. Additional embodiments include a system and storage medium for performing computer system cloning.

### FIELD OF THE INVENTION

The present invention relates generally to computer system cloning. More particularly, the present invention relates to performing computer system cloning and customization using a pull methodology.

### BACKGROUND OF THE INVENTION

Native installation of operating systems and applications can be time consuming and error prone. For example, a typical corporation may have several hundred personal computers that require standard corporate software and operating systems. In addition, each personal computer may require application software that is specific to a particular business function. Each business site or location may also require particular customizations, such as site specific printer addresses, to be added to each personal computer. Costs can be reduced significantly by having standard methods of building, maintaining, and updating these layers of software on each personal computer. Without standards, each business unit and site would require computer specialists to assist in problem resolution and maintenance. Potentially, each personal computer could have a unique software configuration and problem resolution would be very time consuming. These same issues of standardization also apply to server machines and other types of client machines.

Disk imaging software takes a “snap-shot” of a computer system and saves it to a file. This snap-shot can then be recreated on another computer and the result is two computers that contain identical software. Disk imaging software can be used to perform functions that include: distributing new operating systems, updating an application suite, and managing multiple workstation images. Because of its ease of use and fast speed, disk imaging software, also referred to as cloning, has solidified its place in the industry by allowing companies to simplify client deployment and reduce costs by putting a client standardization effort in place.

Current cloning software does not address at least two important issues. First, there is currently no TCP/IP based solution that allows a client to request a build. This is a problem because the trend in major software companies is to move away from NetBIOS and NetBEUI and towards global networks such as the Internet. Current cloning software does support the sending of a single image file across a network connection to multiple connections at the same time. The software uses a push methodology where clients are setup and the client systems wait for an administrator to send them the image files. This method of software distribution requires server side administration, and currently does not support a pull methodology where client systems can request the build.

The second major issue not addressed in current software solutions has to do with the currency and granularity of the system snap-shot. From the moment a snapshot is taken the system image is out of date because of operating system, application, and business updates. Using current cloning software there is no way to edit the contents of the system image without remastering and recreating the master image files.

### SUMMARY OF THE INVENTION

An exemplary embodiment of the present invention is a method and system for performing computer system cloning. A program on a client system requests a system image and a system customization from a server system. Space requirements are received from the server system and then the client system uses these space requirements to set up temporary storage space. An image file corresponding to the system image that was requested is then received from the server system and stored in the temporary storage space. The client system then recreates the system image from the image files. The image files are then deleted from the temporary storage space on the client system. A customization file corresponding to the requested system customization is then received from the server system and stored in the temporary storage space on the client system. The customization file is applied to the system image on the client system and then the temporary storage space is deleted. Additional embodiments include a system and storage medium for performing computer system cloning.

### BRIEF DESCRIPTION OF THE DRAWINGS

FIG. 1 is a block diagram of an exemplary embodiment of a system for performing computer system cloning.

FIG. 2 is a flowchart of an exemplary process for performing computer system cloning.

### DETAILED DESCRIPTION OF THE INVENTION

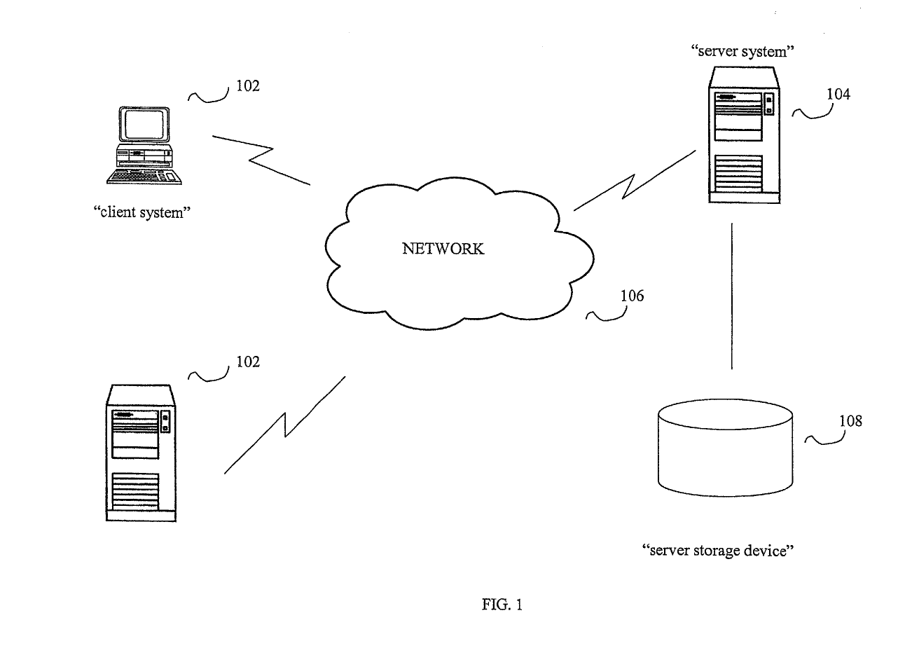

FIG. 1 is a block diagram of an exemplary system for performing computer system cloning. The system of FIG. 1 includes one or more client systems 102 through which a client application will request a system image from a server system 104. The client systems 102 are coupled to a server system 104 via a network 106. In a preferred embodiment, the client system 102 executes a program that requests image files and customization files from the server system 104. The client system 102 may be any type of computer system known in the art. In addition, the client system 102 hardware could be any type of computer hardware that is known in the art. In an exemplary embodiment the client system 102 is a personal computer. The client systems 102 store the requested image and customization files. In an exemplary embodiment the client systems 102 also store application software for interacting with the server system 104 in order to carry out the functions described herein.

The network 106 may be any type of known network including a wide area network (WAN), a global network (e.g., Internet), or a local area network (LAN). The client system 102 may be coupled to the server system 104 through multiple networks (e.g., intranet and Internet) so that not all client systems 102 are coupled to the server system 104 through the same network. One or more of the client systems 102 and the server system 104 may be connected to network 106 in a wireless fashion and network 106 may be a wireless network. In a preferred embodiment, network 106 is an Intranet and each client system 102 executes a program to contact the server system 104 through the network 106. In a preferred embodiment the communication protocol is Transmission Control Protocol/Internet Protocol (TCP/IP).

The server system 104 may be implemented using a server operating in response to a computer program stored in a storage medium accessible by the server. The server system 104 may operate as a network server (e.g., an FTP server) to communicate with the client systems 102. The server system 104 handles sending and receiving information to and from client systems 102 and can perform associated tasks. The server system 104 may also include a firewall to prevent unauthorized access to the server system 104 and enforce any limitations on authorized access. For instance, an administrator may have access to the entire system and have authority to modify portions of the system. The firewall may be implemented using conventional hardware and/or software as is known in the art.

In an exemplary embodiment of the present invention, the client system 102 executes a program that requests a menu of available options from the server system 104. These options include the system image files that are available for cloning as well as business unit and business site specific customizations. The customizations may include applications and device drivers that are business function or business site specific. An exemplary embodiment also includes an application program, running on the client system 102, that estimates how much temporary storage space will be required on the client system 102 in order to build the requested system image and system customizations. The files on the server system 104 contain the sizing information for each system image file and each system customization file.

Storage device 108 may be implemented using a variety of devices for storing electronic information (e.g. file transfer protocol (FTP)). It is understood that storage device 108 may be implemented using memory contained in server system 104 or may be a separate physical device. Storage device 108 is logically addressable as a consolidated data source across a distributed environment such as network system 106. The implementation of local and wide-area database management systems to achieve the functionality of storage device 108 will be readily understood by those skilled in the art. Information stored in storage device 108 is retrieved and manipulated via server system 104. Storage device 108 contains the image files and customization files which will be retrieved and sent to a client system 102. The server system 104 may also operate as a database server and coordinate access to application data including data stored on storage device 108.

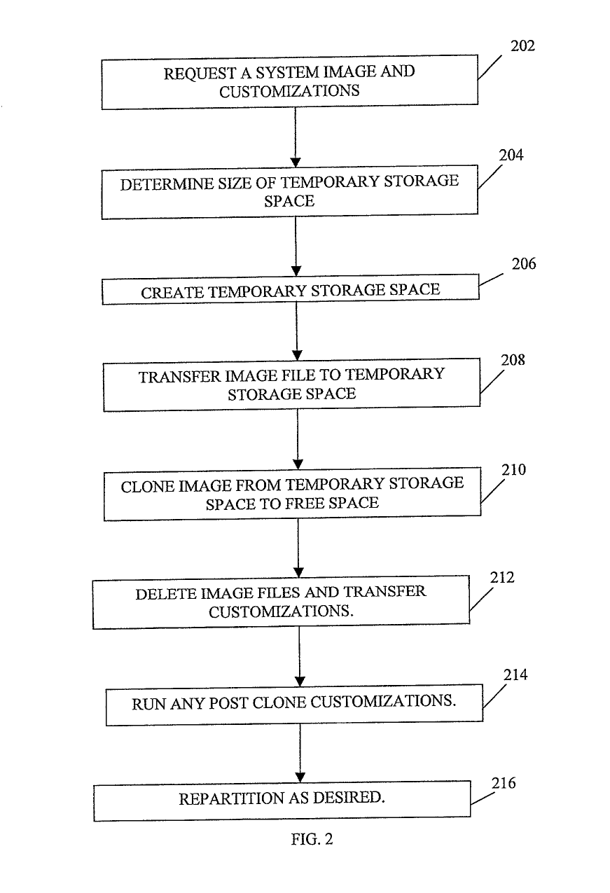

FIG. 2 is a flowchart of an exemplary process for performing computer system cloning. At step 202 a client system 102 requests system and image customizations from the server system 104. In an exemplary embodiment the client system 102 contacts the server system 104 with a request for a system update. The server system 104 would respond with a file that contains a menu of the options available for the system image and system customizations. The client system 102 would then pick from this list and communicate the choice back to the server system 104. In an exemplary embodiment, system image and system customization file suggestions could be made based on business unit, hardware machine or business location. In step 204, based on the system image and system customizations requested by the client system 102, the client system 102 will run an application to determine the required size for a temporary storage space on the client system 102.

At step 206 in FIG. 2, an application on the client system will delete all current partitions on the target drive for the system image and system customization. Then, a temporary storage space (e.g. a partition, a writeable CD, a RAM drive) will be created on the client system 102. Next, at step 208, the image files corresponding to the requested system image are transferred, from the storage device 108 connected to the server system 104, to the temporary storage space on the client system 102 that was created at step 206. At step 210, the image files are cloned from the temporary storage space on the client system 102 to the free space on the client system 102. This step is performed using a cloning tool on the client system 102 to restore the system image from the image files. At step 212, the image files are deleted from the temporary storage space and the customization files corresponding to the requested system customization are transferred from the storage device 108 on the server system 104, to the temporary storage space on the client system 102. The client system 102 is then rebooted, at step 214, and then the customizations stored in the temporary storage space are applied to the system image on the client system 102. After the customizations have been applied, step 216 is performed to remove the temporary storage space from the client system and then to format or partition the target drive on client system 102.

The present invention provides improvements in computer system cloning. The present invention performs a process that allows cloning using a TCP/IP based solution. This allows cloning to be requested and performed over an intranet or the Internet. This ability to use WAN technology transfer cloning data removes nationwide and geographic boundaries on computer system cloning. Computer system cloning is no longer restricted to particular sub-nets or particular countries. In addition, the ability to use a pull methodology removes the need for a server side administrator to perform the software distribution.

Another advantage of the present invention is that it provides an automated way to update a computer system with customizations. Using the present invention, a corporation could have several layers of customization available to support employees with varying requirements. For example, a corporation could support one or more system images for different hardware and software environments. In addition, a corporation could have at least two layers of customization available. The first layer could be based on the type of business unit that the client system 102 supports, for example, a marketing department could require different applications and customizations than a research department. The second layer could be based on the physical site where the client system 102 is located. The New York site customization may have certain printer and fax addresses and the California site other addresses. This layered approach provides the advantages of standardization but also allows for increased flexibility. The layered approach allows customizations to change without requiring that the entire system image be remastered.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore, it is intended that the invention not be limited to the particular embodiments for carrying out this invention, but that the invention will include all embodiments falling within the scope of the appended claims.

What is claimed is:

1. A method for performing computer system cloning, said method comprising:
requesting a system image and a system customization from a server, wherein said requesting is initiated by a client system;
receiving space requirements for said system image and said system customization from said server;
creating temporary storage space on said client system based on said space requirements;
receiving an image file from said server, said receiving including storing said image file in said temporary storage space on said client system, and said image file corresponding to said requested system image;
recreating said system image on said client system in response to said image file;
deleting said image file from said temporary storage space;
receiving a customization file from said server, said receiving including storing said customization file in said temporary storage space on said client system, and said customization file corresponding to said requested system customization;
applying said customization file to said system image on said client system; and
deleting said temporary storage space on said client system.

2. The method of claim 1 wherein said system customization includes site specific computer settings.

3. The method of claim 1 wherein said system customization includes business unit specific computer settings.

4. The method of claim 1 further comprising:
receiving a menu of options from said server in response to a request from said client system.

5. The method of claim 1 further comprising:
receiving a recommended system image and system customization from said server in response to a request from said client system.

6. The method of claim 1 wherein said recreating is performed using a cloning tool.

7. A system for performing computer system cloning, said system comprising:
a client system in communication with said network, said client system implementing a process comprising:
requesting a system image and a system customization from a server, wherein said requesting is initiated by a client system;
receiving space requirements for said system image and said system customization from said server;
creating temporary storage space on said client system based on said space requirements;
receiving an image file from said server, said receiving including storing said image file in said temporary storage space on said client system, and said image file corresponding to said requested system image;
recreating said system image on said client system in response to said image file;
deleting said image file from said temporary storage space;
receiving a customization file from said server, said receiving including storing said customization file in said temporary storage space on said client system, and said customization file corresponding to said requested system customization;
applying said customization file to said system image on said client system; and
deleting said temporary storage space on said client system.

8. The system of claim 7 wherein said system customization includes site specific computer settings.

9. The system of claim 7 wherein said system customization includes business unit specific computer settings.

10. The system of claim 7 further comprising:
receiving a menu of options from said server in response to a request from said client system.

11. The system of claim 7 further comprising:
receiving a recommended system image and system customization from said server in response to a request from said client system.

12. The system of claim 7 wherein said recreating is performed using a cloning tool.

13. The system of claim 7 wherein said network is a WAN.

14. The system of claim 7 wherein said network is the Internet.

15. The system of claim 7 wherein said network is an Intranet.

16. The system of claim 7 wherein said network communicates using TCP/IP.

17. A storage medium encoded with machine-readable computer program code for performing computer system cloning, the storage medium storing instructions for causing a client system to implement a method comprising:
requesting a system image and a system customization from a server, wherein said requesting is initiated by a client system;
receiving space requirements for said system image and said system customization from said server;
creating temporary storage space on said client system based on said space requirements;
receiving an image file from said server, said receiving including storing said image file in said temporary storage space on said client system, and said image file corresponding to said requested system image;
recreating said system image on said client system in response to said image file;
deleting said image file from said temporary storage space;
receiving a customization file from said server, said receiving including storing said customization file in said temporary storage space on said client system, and said customization file corresponding to said requested system customization;
applying said customization file to said system image on said client system; and
deleting said temporary storage space on said client system.

18. The storage medium of claim 17 wherein said system customization includes site specific computer settings.

19. The storage medium of claim 17 wherein said system customization includes business unit specific computer settings.

20. The storage medium of claim 17 further comprising instructions for causing the client system to implement:
receiving a menu of options from said server in response to a request from said client system.

21. The storage medium of claim 17 further comprising instructions for causing the client system to implement:
receiving a recommended system image and system customization from said server in response to a request from said client system.

22. The storage medium of claim 17 wherein said recreating is performed using a cloning tool.
